(19) United States
(12) Patent Application Publication
(10) Pub. No.: US 2018/0329057 A1
(43) Pub. Date: Nov. 15, 2018

(54) POSITIONING SYSTEM AND POSITIONING METHOD

(71) Applicant: MITSUBISHI ELECTRIC CORPORATION, Tokyo (JP)

(72) Inventors: Ryoji ONO, Tokyo (JP); Hideto AIKAWA, Tokyo (JP); Hidenori ISHIDA, Tokyo (JP)

(73) Assignee: MITSUBISHI ELECTRIC CORPORATION, Tokyo (JP)

(21) Appl. No.: 15/777,959

(22) PCT Filed: Jan. 19, 2016
(86) PCT No.: PCT/JP2016/051445

§ 371 Date: May 22, 2018

(51) Int. Cl. G01S 15/74

(52) U.S. Cl. CPC G01S 15/74

(57) ABSTRACT

There are included: a device to be located (500) that transmits sound waves; a positioning device (100) that transmits sound waves to the device to be located (500) upon receiving the sound waves transmitted from the device to be located (500); and a positioning execution device (300) that calculates a distance between the positioning device (100) and the device to be located (500) by using required time for the device to be located (500) to receive the sound waves transmitted by the positioning device (100) after transmitting the sound waves and return delay time before the positioning device (100) transmits the sound waves to the device to be located (500) after receiving the sound waves, and calculates a location of the device to be located (500) by using the distance between the positioning device (100) and the device to be located (500).

### TECHNICAL FIELD

The present invention relates to a positioning system and a positioning method for performing positioning using wireless communication and sound wave transmission and reception.

### BACKGROUND ART

Various functions and services are provided by detecting the location of a device or equipment held by a person.

A Global Positioning System (GPS) is a typical technique used for location detection. In GPS, a radio wave for positioning is transmitted from a satellite to the ground so that a device receiving this radio wave on the ground can calculate the location of the device. Navigation systems for vehicles and pedestrians are provided using such GPS. GPS positioning is mainly used outdoors since a radio wave needs to be received from a satellite, whereby indoor use of such positioning is generally difficult.

Thus, indoor location detection uses positioning by sound waves.

Patent Literature 1 discloses a method in which, with ID information periodically transmitted from an IC tag, a base station is time synchronized with the IC tag and transmits sound waves, so that the location of the IC tag is detected by a difference between the time of time synchronization as well as transmission of the sound waves and the time of detection of the sound waves on the IC tag. This technique detects the location of the IC tag by measuring the distance between the IC tag and the base station a plurality of times.

Patent Literature 2 discloses a method in which, with non-contact power supplied to an IC tag, the IC tag transmits ID information and sound waves, which are received by a plurality of time-synchronized base stations so that the location of the IC tag is detected by measuring the distance between the IC tag and each of the base stations.

Patent Literature 3 discloses a method in which light and sound waves are simultaneously transmitted from a plurality of transmitters so that the location of a receiver is detected by differences in time at which the receiver receives the light and sound waves from the transmitters.

### CITATION LIST

### Patent Literature

Patent Literature 1: JP 2009-162732 A

Patent Literature 2: JP 2006-329681 A

Patent Literature 3: JP 2007-093313 A

### SUMMARY OF INVENTION

### Technical Problem

In any of Patent Literatures 1 to 3, the sound waves are transmitted or received in one direction from a device used in location detection to a device to be located, or from the device to be located to the device used in location detection. At this time, in any of the literatures, the devices perform timing synchronization in order to measure the time required for the sound waves to propagate from one side to the other.

However, the strict time synchronization as in Patent Literature 1 is required in order to strictly synchronize the timing between remote devices. Alternatively, the plurality of transceivers is required as in Patent Literature 3, which makes the configuration of the device complex.

Moreover, in any of the literature, a processing delay in the device causes a lag between the time at which the sound waves are actually transmitted or received and the time measured by the device, whereby a measurement error is generated.

It is an object of the present invention to calculate location information of a device to be located with high accuracy.

### Solution to Problem

A positioning system according to the present invention includes:

a device to be located to transmit sound waves;

a positioning device to transmit sound waves to the device to be located upon receiving the sound waves transmitted from the device to be located; and

a positioning execution device to calculate a distance between the positioning device and the device to be located by using required time for the device to be located to receive the sound waves transmitted by the positioning device after transmitting the sound waves and return delay time before the positioning device transmits the sound waves to the device to be located after receiving the sound waves, and to calculate a location of the device to be located by using the distance between the positioning device and the device to be located.

### Advantageous Effects of Invention

The positioning system according to the present invention includes the device to be located that transmits the sound waves and the positioning device that transmits the sound waves to the device to be located upon receiving the sound waves transmitted from the device to be located, where the distance between the positioning device and the device to be located is calculated by using the required time for the device to be located to receive the sound waves transmitted by the positioning device after transmitting the sound waves and the return delay time before the positioning device transmits the sound waves to the device to be located after receiving the sound waves, so that the location information of the device to be located can be calculated with high accuracy with a simple configuration.

### BRIEF DESCRIPTION OF DRAWINGS

FIG. 1 is a block diagram of a positioning system 800 according to a first embodiment.

FIG. 2 is a block diagram of a positioning execution device 300 according to the first embodiment.

FIG. 3 is a block diagram of a positioning instruction device 200 according to the first embodiment.

FIG. 4 is a block diagram of a positioning device 100 according to the first embodiment.

FIG. 5 is a block diagram of a device to be located 500 according to the first embodiment.

FIG. 6 is an example of the use of the positioning system 800 according to the first embodiment.

FIG. 7 is an example of the use of the positioning system 800 according to the first embodiment.

FIG. 8 is an operation sequence diagram of the positioning system 800 according to the first embodiment.

FIG. 9 is a flowchart of a positioning execution process S300 of the positioning execution device 300 according to the first embodiment.

FIG. 10 is an example of the configuration of a positioning request 31 according to the first embodiment.

FIG. 11 is an example of the configuration of a positioning response 22 according to the first embodiment.

FIG. 12 is an example of the configuration of a positioning request 32 according to the first embodiment.

FIG. 13 is an example of the configuration of a positioning response 51 according to the first embodiment.

FIG. 14 is an example of the configuration of a positioning result 23 according to the first embodiment.

FIG. 15 is an example of the configuration of a positioning result 52 according to the first embodiment.

FIG. 16 is a flowchart of a positioning instruction process S200 of the positioning instruction device 200 according to the first embodiment.

FIG. 17 is an example of the configuration of a positioning instruction 21 according to the first embodiment.

FIG. 18 is an example of the configuration of a positioning instruction response 11 according to the first embodiment.

FIG. 19 is an example of the configuration of a positioning result 12 according to the first embodiment.

FIG. 20 is a flowchart of a positioning device process S100 of the positioning device 100 according to the first embodiment.

FIG. 21 is a flowchart of a located process S500 of the device to be located 500 according to the first embodiment.

FIG. 22 is an example of an apparatus including the positioning execution device and the device to be located according to the first embodiment.

FIG. 23 is an example of an apparatus including the positioning instruction device and the positioning device according to the first embodiment.

FIG. 24 is an example of an apparatus including all of the positioning execution device, the positioning instruction device, the positioning device, and the device to be located according to the first embodiment.

FIG. 25 is an example of the use of the positioning system 800 according to the first embodiment.

FIG. 26 is an example of the use of the positioning system 800 according to the first embodiment.

FIG. 27 is a variation of the configuration of the positioning execution device 300 according to the first embodiment.

FIG. 28 is a variation of the configuration of the positioning instruction device 200 according to the first embodiment.

FIG. 29 is a variation of the configuration of the positioning device 100 according to the first embodiment.

FIG. 30 is a variation of the configuration of the device to be located 500 according to the first embodiment.

FIG. 31 is an operation sequence diagram of a positioning system 800x according to a second embodiment.

FIG. 32 is an example of the configuration of a positioning instruction 21x according to the second embodiment.

FIG. 33 is an example of the configuration of a positioning result 12x according to the second embodiment.

FIG. 34 is a flowchart of a positioning device process S100x of the positioning device 100 according to the second embodiment.

FIG. 35 is an example of the configuration of a positioning result 23x according to the second embodiment.

FIG. 36 is a flowchart of a located process S500x of the device to be located 500 according to the second embodiment.

FIG. 37 is an example of the configuration of a positioning result 52x according to the second embodiment.

### DESCRIPTION OF EMBODIMENTS

### First Embodiment

Description of Configuration

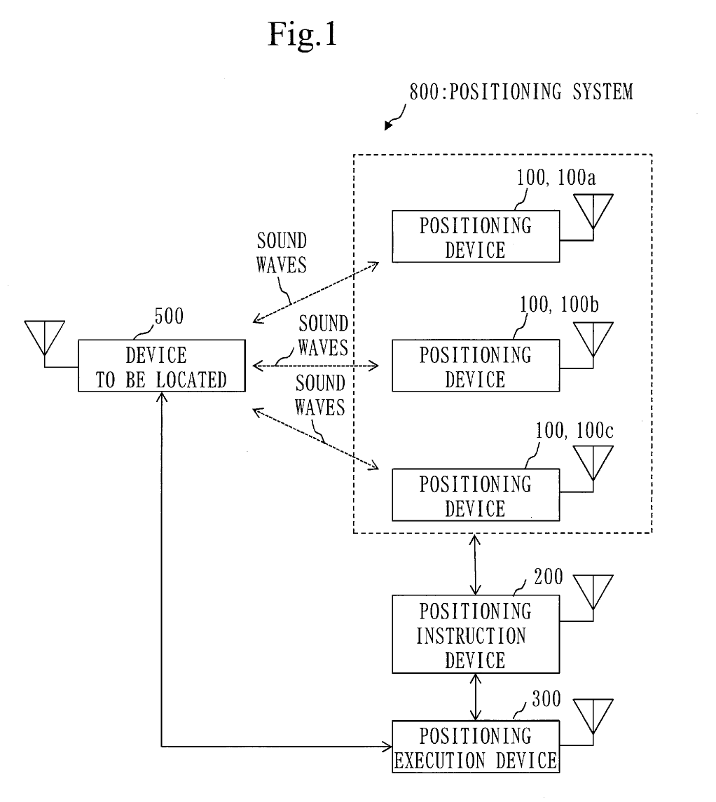

The configuration of a positioning system 800 according to the present embodiment will be described with reference to FIG. 1. The positioning system 800 includes a positioning execution device 300, a positioning instruction device 200, at least three positioning devices 100, and a device to be located 500. In FIG. 1, the positioning system 800 includes positioning devices 100a, 100b, and 100c as the positioning devices 100. In the following description, all or any of the positioning devices 100a, 100b, and 100c may be described as the positioning device 100.

The devices included in the positioning system 800 each have a communication part that performs wireless communication to be able to perform wireless communication with each other. That is, the positioning instruction device 200 and the positioning execution device 300 perform wireless communication with each other. Moreover, the positioning instruction device 200 and the positioning device 100 perform wireless communication with each other. The positioning device 100 and the device to be located 500 each have a speaker capable of outputting sound waves and a microphone capable of receiving sound waves to be able to mutually transmit or receive sound waves.

Although the present embodiment illustrates an example of using three of the positioning devices 100, three or more of the positioning devices may be used. That is, the positioning system 800 includes at least three of the positioning devices 100. Moreover, although the present embodiment illustrates an example of using wireless communication, wired communication such as Ethernet (registered trademark) may be used between some or all of the devices.

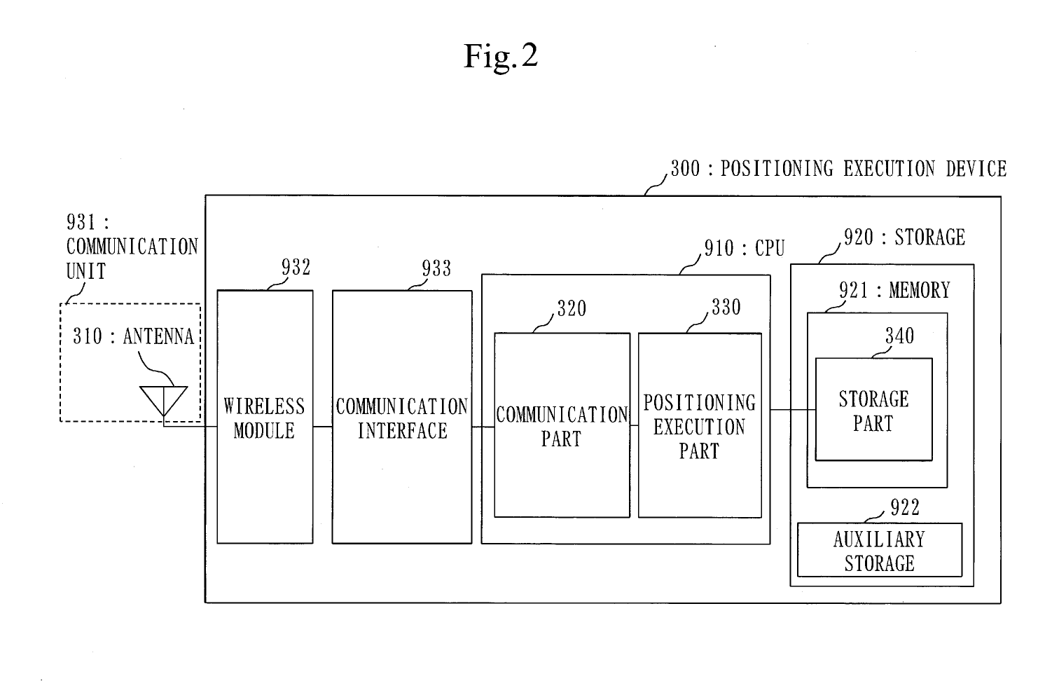

The configuration of the positioning execution device 300 according to the present embodiment will be described with reference to FIG. 2.

The positioning execution device 300 is a computer in the present embodiment. The positioning execution device 300 includes hardware such as a Central Processing Unit (CPU) 910, a storage 920, a communication unit 931, a wireless module 932, and a communication interface 933. The storage 920 includes a memory 921 and an auxiliary storage 922. The communication unit 931 is specifically an antenna 310.

The positioning execution device 300 includes a communication part 320, a positioning execution part 330, and a storage part 340 as a functional configuration. In the following description, the functions of the communication part 320 and the positioning execution part 330 in the positioning execution device 300 are referred to as the functions of “parts” of the positioning execution device 300. The functions of the “parts” of the positioning execution device 300 are implemented in software.

Moreover, the storage part 340 is implemented by the memory 921.

The positioning execution part 330 executes positioning by making a request to the positioning instruction device 200 and the device to be located 500. The communication part 320 communicates with another device via the antenna 310, the wireless module 932, and the communication interface 933.

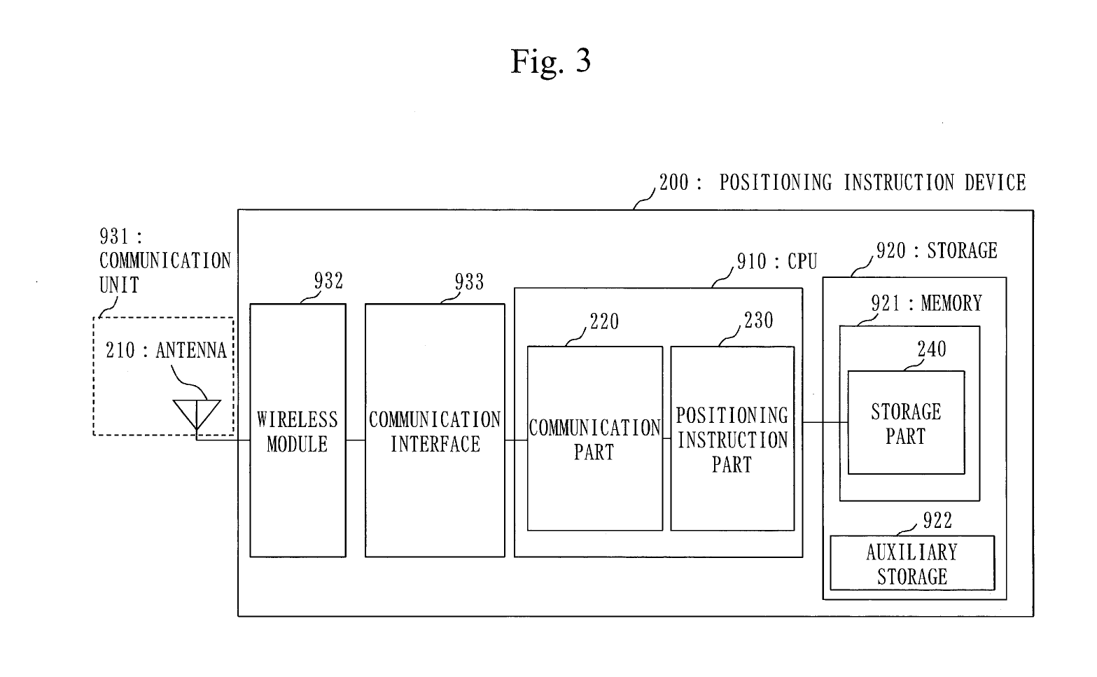

The configuration of the positioning instruction device 200 according to the present embodiment will be described with reference to FIG. 3.

The positioning instruction device 200 is a computer in the present embodiment. The positioning instruction device 200 includes hardware such as the CPU 910, the storage 920, the communication unit 931, the wireless module 932, and the communication interface 933. The storage 920 includes the memory 921 and the auxiliary storage 922. The communication unit 931 is specifically an antenna 210.

The positioning instruction device 200 includes a communication part 220, a positioning instruction part 230, and a storage part 240 as a functional configuration. In the following description, the functions of the communication part 220 and the positioning instruction part 230 in the positioning instruction device 200 are referred to as the functions of “parts” of the positioning instruction device 200. The functions of the “parts” of the positioning instruction device 200 are implemented in software.

Moreover, the storage part 240 is implemented by the memory 921.

The positioning instruction part 230 instructs the positioning device 100 to perform positioning in response to a request from the positioning execution device 300. The communication part 220 communicates with another device via the antenna 210, the wireless module 932, and the communication interface 933.

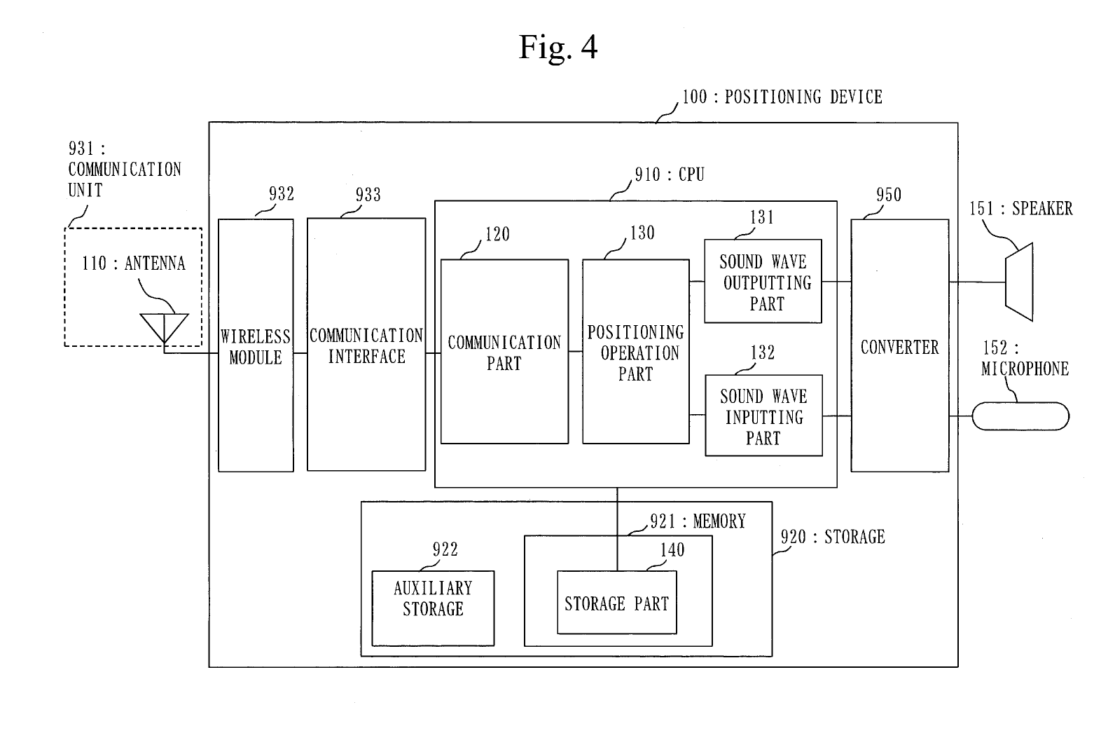

The configuration of the positioning device 100 according to the present embodiment will be described with reference to FIG. 4.

The positioning device 100 is a computer in the present embodiment. The positioning device 100 includes hardware such as the CPU 910, the storage 920, the communication unit 931, the wireless module 932, the communication interface 933, a converter 950, a speaker 151, and a microphone 152. The storage 920 includes the memory 921 and the auxiliary storage 922. The communication unit 931 is specifically an antenna 110.

The positioning device 100 includes a communication part 120, a positioning operation part 130, a sound wave outputting part 131, a sound wave inputting part 132, and a storage part 140 as a functional configuration. In the following description, the functions of the communication part 120, the positioning operation part 130, the sound wave outputting part 131, and the sound wave inputting part 132 in the positioning device 100 are referred to as the functions of “parts” of the positioning device 100. The functions of the “parts” of the positioning device 100 are implemented in software.

Moreover, the storage part 140 is implemented by the memory 921.

The positioning operation part 130 performs positioning in accordance with an instruction from the positioning instruction device 200. The sound wave outputting part 131 is connected to the speaker 151 and outputs sound waves for positioning via the speaker 151. The sound wave inputting part 132 is connected to the microphone 152 and receives input of sound waves for positioning via the microphone 152. The communication part 120 communicates with another device via the antenna 110, the wireless module 932, and the communication interface 933.

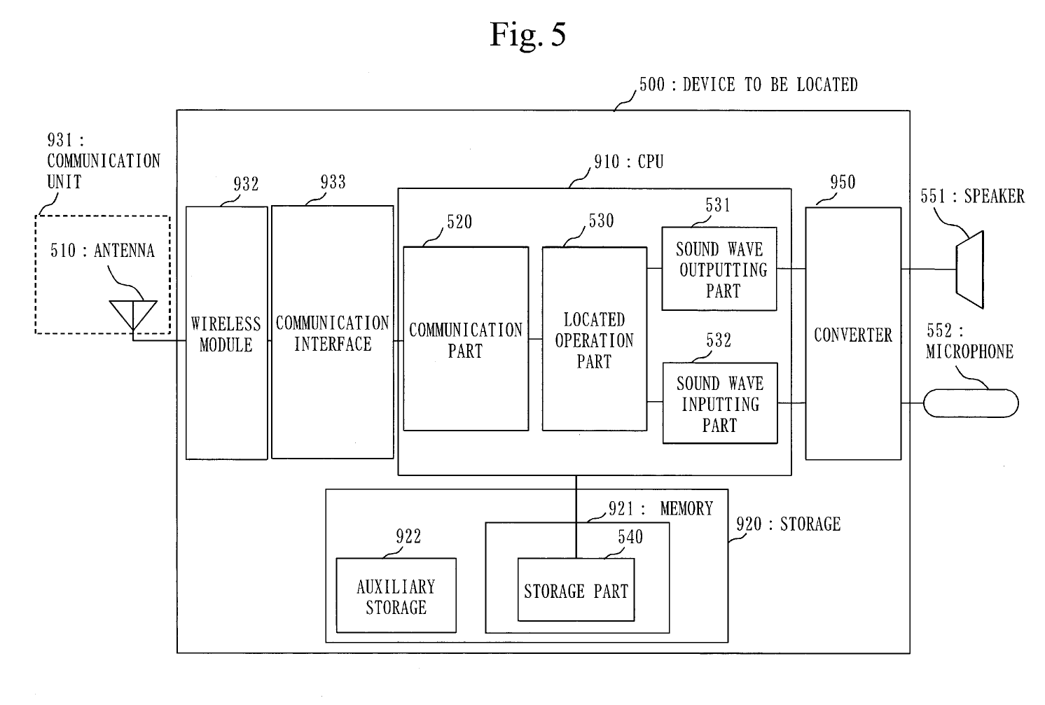

The configuration of the device to be located 500 according to the present embodiment will be described with reference to FIG. 5.

The device to be located 500 is a computer in the present embodiment. The device to be located 500 includes hardware such as the CPU 910, the storage 920, the communication unit 931, the wireless module 932, the communication interface 933, the converter 950, a speaker 551, and a microphone 552. The storage 920 includes the memory 921 and the auxiliary storage 922. The communication unit 931 is specifically an antenna 510.

The device to be located 500 includes a communication part 520, a located operation part 530, a sound wave outputting part 531, a sound wave inputting part 532, and a storage part 540 as a functional configuration. In the following description, the functions of the communication part 520, the located operation part 530, the sound wave outputting part 531, and the sound wave inputting part 532 in the device to be located 500 are referred to as the functions of “parts” of the device to be located 500. The functions of the “parts” of the device to be located 500 are implemented in software.

Moreover, the storage part 540 is implemented by the memory 921.

The located operation part 530 performs positioning in response to a request from the positioning execution device 300. The sound wave outputting part 531 is connected to the speaker 551 and outputs sound waves for positioning via the speaker 551. The sound wave inputting part 532 is connected to the microphone 552 and receives input of sound waves for positioning via the microphone 552. The communication part 520 communicates with another device via the antenna 510, the wireless module 932, and the communication interface 933.

In each of the devices illustrated in FIGS. 2 to 5, the CPU 910 is connected to the other hardware via a signal line to control the other hardware.

The CPU 910 is an integrated circuit (IC) that performs processing. The CPU 910 is a processor.

The auxiliary storage 922 is specifically a read only memory (ROM), a flash memory, or a hard disk drive (HDD). The memory 921 is specifically a random access memory (RAM). The storage part in each of the devices in FIGS. 2 to 5 is implemented by the memory 921 but may be implemented by both the auxiliary storage 922 and the memory 921.

The converter 950 converts a digital signal from the CPU 910 into an analog signal and outputs the signal to the outside. The converter 950 also converts an analog signal from the outside into a digital signal and outputs the signal to the CPU 910. The converter 950 is connected to the microphone and the speaker.

The wireless module 932 is connected to the antenna and implements the function of the communication part.

The communication interface 933 is an interface for communication between the CPU 910 and the wireless module 932. The communication interface 933 can specifically include a universal asynchronous receiver transmitter (UART) or Ethernet (registered trademark).

The auxiliary storage 922 of each device stores a program that implements the functions of the “parts” of each device. The program for implementing the functions of the “parts” of each device is loaded into the memory 921 of each device, read by the CPU 910 of each device, and executed by the CPU 910 of each device.

Information, data, a signal value, and a variable value representing a result of processing by the “part” in each device are stored in the auxiliary storage 922, the memory 921, or a register or cache memory in the CPU 910 of each device.

The program for implementing the functions of the “parts” of each device may be stored in a portable recording medium such as a magnetic disk, a flexible disk, an optical disk, a compact disk, a Blu-ray (registered trademark) disk, or a digital versatile disc (DVD).

Note that what is called a positioning program product is a storage medium and a storage which store the program implementing the functions described as the “parts”, and in which a computer readable program is loaded regardless of the external format.

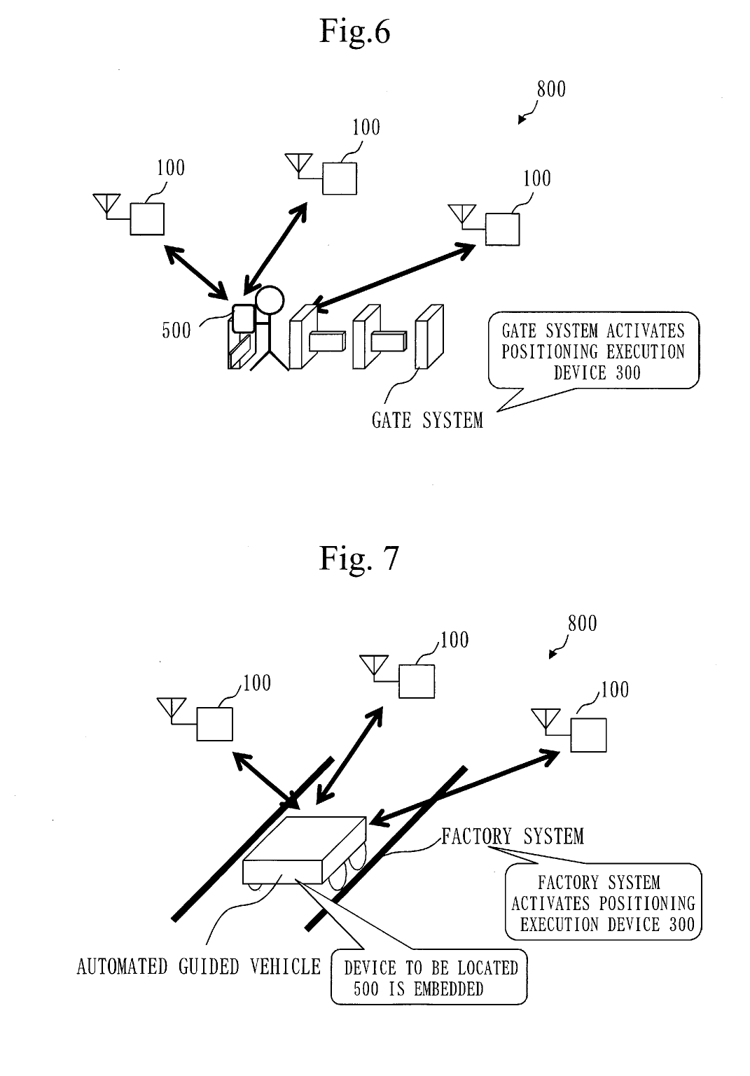

Next, an example of the use of the positioning system 800 according to the present embodiment will be described with reference to FIGS. 6 and 7.

FIG. 6 illustrates an example of the positioning system 800 used for gate detection in a security flapper gate made up of a plurality of gates. The security flapper gate made up of the plurality of gates is called a gate system. In the positioning system 800 of FIG. 6, the positioning device 100 is placed on the wall or the like near the gate. A user holds the device to be located 500, specifically a smart phone on which an application implementing the located operation part 530 is running. The gate system activates the positioning execution device 300 upon detecting an approach of the user by radio waves emitted from the smart phone or the like. Once the positioning execution device 300 is activated, the positioning system 800 identifies the location of the device to be located 500 possessed by the user. The location of the device to be located 500 identified in this manner can then be used to identify which gate among the plurality of gates the user is about to pass through, whereby the gate can be opened without an operation by the user.

FIG. 7 illustrates an example of the positioning system 800 used to detect the location of an automated guided vehicle. The positioning device 100 is placed on the wall or the like in a factory. The device to be located 500 is embedded in the automated guided vehicle. When intending to acquire or display the location of the automated guided vehicle, an in-house system can acquire the location of the automated guided vehicle by activating the positioning execution device 300 connected to or incorporated in the in-house system.

Description of Operation

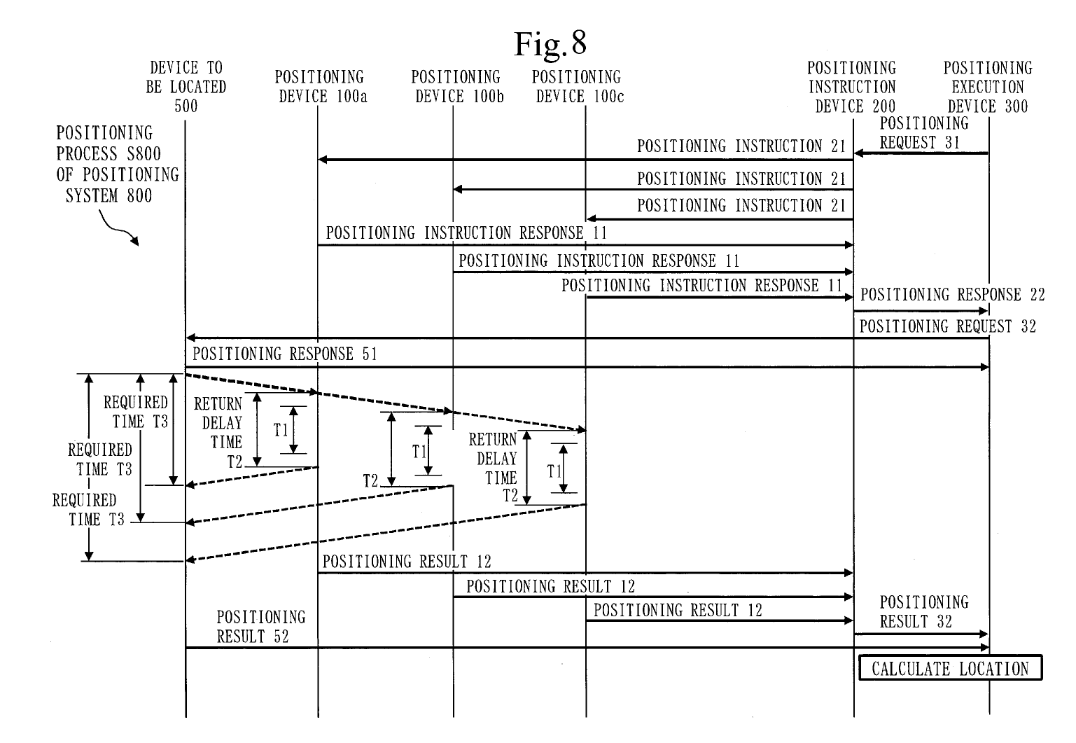

The operation sequence of a positioning method 610 and a positioning process S800 of the positioning system 800 according to the present embodiment will be described with reference to FIG. 8.

The positioning execution device 300 transmits a positioning request 31 that requests locating of the device to be located 500.

Upon receiving the positioning request 31, the positioning instruction device 200 transmits to the positioning device 100 a positioning instruction 21 that instructs locating of the device to be located 500 and includes return waiting time T1. Specifically, the positioning instruction device 200 receives the positioning request 31 and then transmits the positioning instruction 21 to each of the positioning devices 100a, 100b, and 100c.

Each of the positioning devices 100a, 100b, and 100c receives the positioning instruction 21 and then transmits a positioning instruction response 11 to the positioning instruction device 200. The positioning instruction device 200 receives the positioning instruction response 11 from each of the positioning devices 100a, 100b, and 100c, and then transmits a positioning response 22 to the positioning execution device 300.

The positioning execution device 300 transmits a positioning request 32 to the device to be located 500. The device to be located 500 receives the positioning request 32 and then transmits a positioning response 51 to the positioning execution device 300.

After transmitting the positioning response 51, the device to be located 500 transmits sound waves.

The positioning device 100 receives the sound waves transmitted from the device to be located 500, and then transmits sound waves to the device to be located 500. The positioning device 100 receives the sound waves transmitted from the device to be located 500, and then transmits the sound waves to the device to be located 500 after the lapse of the return waiting time T1 included in the positioning instruction 21. Specifically, when the sound waves transmitted (output) from the device to be located 500 are received by (input to) each of the positioning devices 100a, 100b, and 100c, each of the positioning devices 100a, 100b, and 100c transmits the sound waves after the return waiting time T1 elapses from the reception of the sound waves.

As described above, when a value different for each of the plurality of positioning devices is specified as the return waiting time T1, the positioning devices transmit the sound waves after waiting for different amounts of time upon detecting the sound waves from the device to be located. The return waiting time T1 provides the following effects.

(1) The order of transmission of the sound waves transmitted from the plurality of positioning devices can be specified.

(2) The plurality of positioning devices can avoid transmitting the sound waves that overlap, that is, the plurality of positioning devices can avoid transmitting the sound waves at the same time.

Each of the positioning devices 100a, 100b, and 100c further measures, as return delay time T2, the time before transmitting the sound waves after receiving the sound waves transmitted from the device to be located 500. The device to be located 500 receives the sound waves transmitted from each of the positioning devices 100a, 100b, and 100c, then measures required time T3 for receiving the sound waves after transmitting the sound waves for each positioning device.

After outputting the sound waves, each of the positioning devices 100a, 100b, and 100c transmits a positioning result 12 to the positioning instruction device 200. The positioning result 12 includes the return delay time T2. That is, the positioning device 100 transmits the return delay time T2 to the positioning instruction device 200.

The positioning instruction device 200 receives the positioning result 12 from each of the positioning devices 100a, 100b, and 100c, and then transmits a positioning result 23 to the positioning execution device 300. The positioning result 23 includes an identifier (ID) of each of the positioning devices 100a, 100b, and 100c in association with the return delay time T2 received from each of the positioning devices 100a, 100b, and 100c. That is, the positioning instruction device 200 transmits the return delay time T2 received from the positioning device 100 to the positioning execution device 300.

After receiving the sound waves output by each of the positioning devices 100a, 100b, and 100c, the device to be located 500 transmits a positioning result 52 to the positioning execution device 300. The positioning result 52 includes the required time T3 in order such as in ascending order. That is, the device to be located 500 transmits the required time T3 to the positioning execution device 300. Here, there will be described a specific example of a method of associating the required time T3 in the positioning result 52 with the return delay time T2 in the positioning result 23.

As described above, the return waiting time T1 can determine in which order the plurality of positioning devices transmits the sound waves. Specifically, there will be described a case where the positioning system 800 according to the present embodiment is used indoors. The positioning system 800 is used within the normal reach of sound waves transmitted with an output that can withstand practical use, that is, an output not causing disturbance or discomfort to the surroundings. For this reason, the distance between the device to be located and the positioning device is limited to about 10 m to 20 m, and the arrival time of the sound waves is at most 0.1 seconds. At this time, when the return waiting time T1 is set to a multiple of a value longer than the maximum value of the arrival time of 0.1 seconds or the like, a difference due to the waiting time T1 is greater than a difference due to the arrival time so that the positioning device ID associated with each of T1, T2, and T3 arranged in ascending order is the same. Accordingly, the required time T3 in the positioning result 52 can be associated with the return delay time T2 in the positioning result 23. Note that not only the above method but another method may be used as the method of associating the required time T3 in the positioning result 52 with the return delay time T2 in the positioning result 23.

The positioning execution device 300 receives the positioning results 23 and 52 from the positioning instruction device 200 and the device to be located 500, and then calculates the location of the device to be located 500 from the return delay time T2 and the required time T3 included in the positioning results 23 and 52. That is, the positioning execution device 300 calculates the distance between the positioning device 100 and the device to be located 500 by using the required time T3 for the device to be located 500 to receive the sound waves transmitted from the positioning device 100 after transmitting the sound waves, and the return delay time T2 before the positioning device 100 transmits the sound waves to the device to be located 500 after receiving the sound waves. The positioning execution device 300 then calculates the location of the device to be located 500 by using the distance between the positioning device 100 and the device to be located 500.

<Positioning Execution Process S300 of Positioning Execution Device 300>

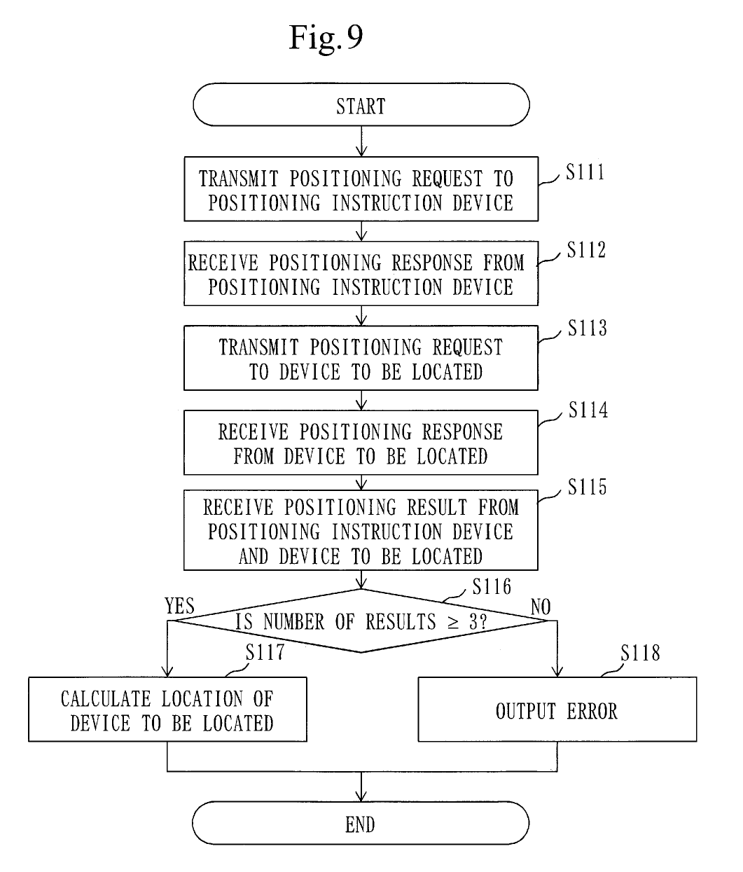

A positioning execution process S300 of the positioning execution device 300 according to the present embodiment will be described with reference to FIG. 9. The positioning execution process S300 is executed by the positioning execution part 330 and the communication part 320 of the positioning execution device 300. The positioning execution part 330 executes transmission and reception via the communication part 320.

In step S111, the positioning execution part 330 of the positioning execution device 300 transmits the positioning request 31 to the positioning instruction device 200.

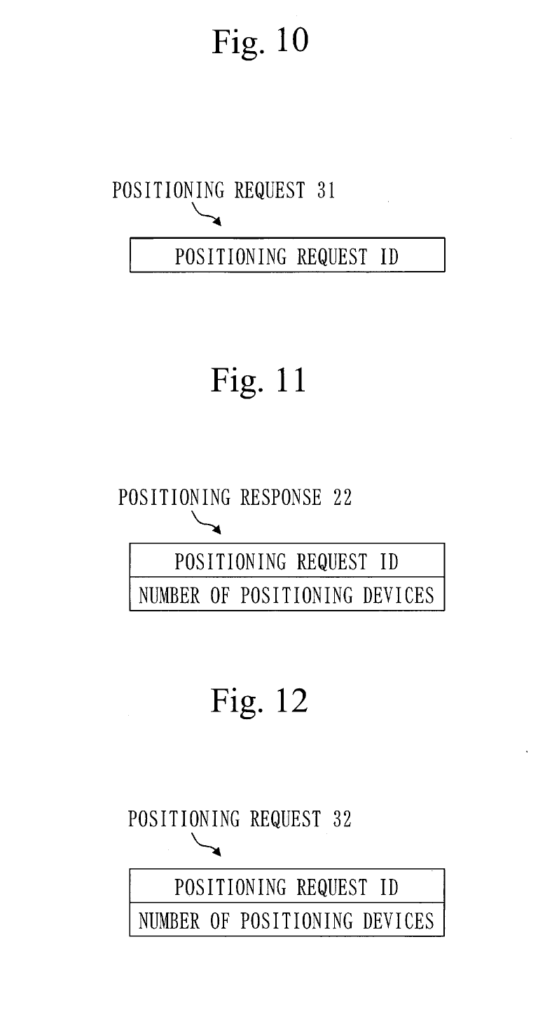

FIG. 10 illustrates an example of the configuration of the positioning request 31. The positioning request 31 includes a positioning request ID that uniquely identifies the positioning request 31.

In step S112, the positioning execution part 330 of the positioning execution device 300 receives the positioning response 22 from the positioning instruction device 200. FIG. 11 illustrates an example of the configuration of the positioning response 22. The positioning response 22 includes the positioning request ID and the number of the positioning devices 100 participating in the measurement.

In step S113, the positioning execution part 330 of the positioning execution device 300 transmits the positioning request 32 to the device to be located 500. FIG.

12 illustrates an example of the configuration of the positioning request 32. The positioning request 32 includes a positioning request ID that uniquely identifies the positioning request 32, and the number of the positioning devices 100 participating in the measurement. The number corresponds to the number received from the positioning instruction device 200 in step S112.

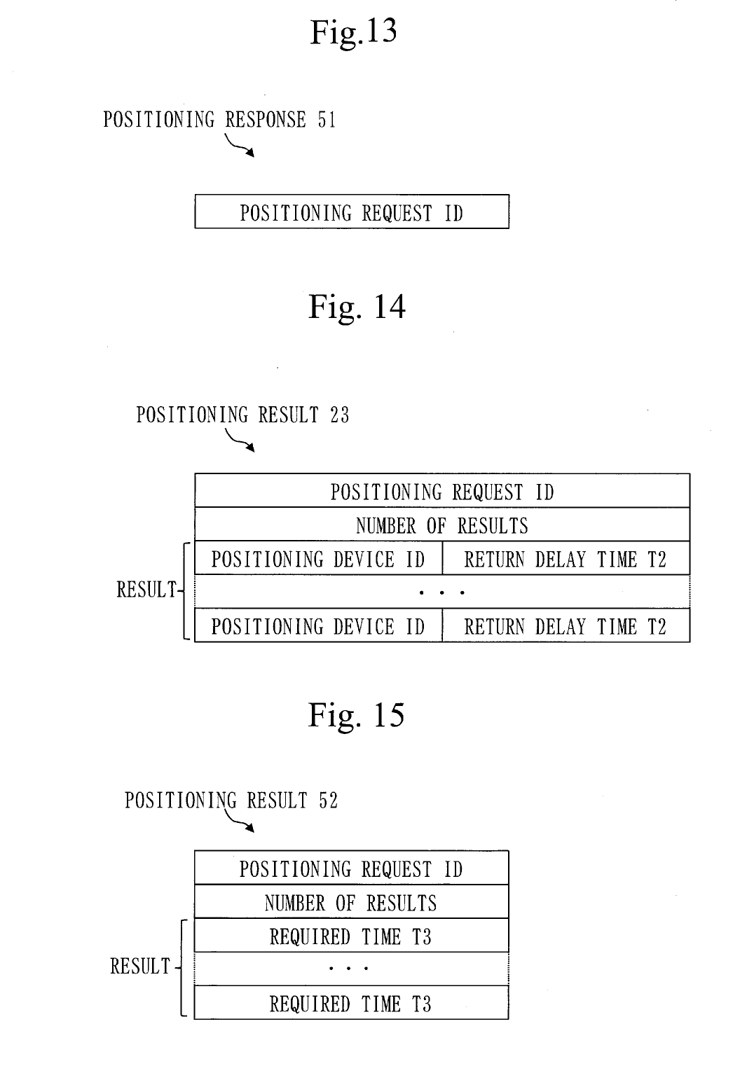

In step S114, the positioning execution part 330 of the positioning execution device 300 receives the positioning response 51 from the device to be located 500. FIG. 13 illustrates an example of the configuration of the positioning response 51. The positioning response 51 includes the positioning request ID.

In step S115, the positioning execution part 330 of the positioning execution device 300 receives the positioning results 23 and 52 from the positioning instruction device 200 and the device to be located 500, respectively. Although not illustrated, the positioning execution part 330 of the positioning execution device 300 waits for the positioning results 23 and 52 from the positioning instruction device 200 and the device to be located 500 until a predetermined time elapses, and continues the process when successfully receiving both of the results. When failing to receive both of the results, the positioning execution part 330 of the positioning execution device 300 outputs an error and ends the process.

Note that either the positioning result 23 from the positioning instruction device 200 or the positioning result 52 from the device to be located 500 may be received first.

FIG. 14 illustrates an example of the configuration of the positioning result 23 from the positioning instruction device 200. The positioning result 23 includes the positioning request ID, the number of results representing the number of results, and one or more results. The result includes a combination of the positioning device ID uniquely identifying the positioning device and the return delay time T2 at the positioning device identified by the positioning device ID. The result is included in the order such as ascending order of the return waiting time T1 instructed by the positioning instruction device 200 to the positioning device 100.

FIG. 15 illustrates an example of the configuration of the positioning result 52 from the device to be located 500. The positioning result 52 includes the positioning request ID, the number of results, and one or more required times. The required time T3 is included in order, such as in ascending order, of the required time T3.

In step S116, the positioning execution part 330 of the positioning execution device 300 compares the number of results included in the positioning result 23 received from the positioning instruction device 200 with the number of results included in the positioning result 52 received from the device to be located 500, thereby determining whether or not the smaller one equals three or more.

If the number of results does not equal three or more, the positioning execution part 330 of the positioning execution device 300 outputs an error in step S118 and ends the process.

If the number of results equals three or more, the positioning execution part 330 of the positioning execution device 300 proceeds to step S117.

In step S117, the positioning execution part 330 of the positioning execution device 300 calculates the location of the device to be located 500 by using the distance between each of at least three of the positioning devices 100 and the device to be located 500. Specifically, the positioning execution part 330 of the positioning execution device 300 calculates the location of the device to be located 500 on the basis of the return delay time T2 included in the positioning result 23 received from the positioning instruction device 200 and the required time T3 included in the positioning result 52 received from the device to be located 500. The distance between each of the positioning devices 100 and the device to be located 500 is obtained as follows from the required time T3 and the return delay time T2 for each of the positioning devices 100.

(Distance)={(required time)−(return delay time)}/(speed of sound)/2

The location of the device to be located 500 can be calculated from the location of each of the positioning devices 100 and the distance calculated above. The positioning execution device holds the location of each of the positioning devices 100 in association with the positioning device ID. Alternatively, the positioning execution device acquires the location of each of the positioning devices 100 from a database in the positioning execution device 300 or outside the positioning execution device 300 by using the positioning device ID as a key. Yet alternatively, the location of the positioning device 100 itself may be used as the positioning device ID.

<Positioning Instruction Process S200 of Positioning Instruction Device 200>

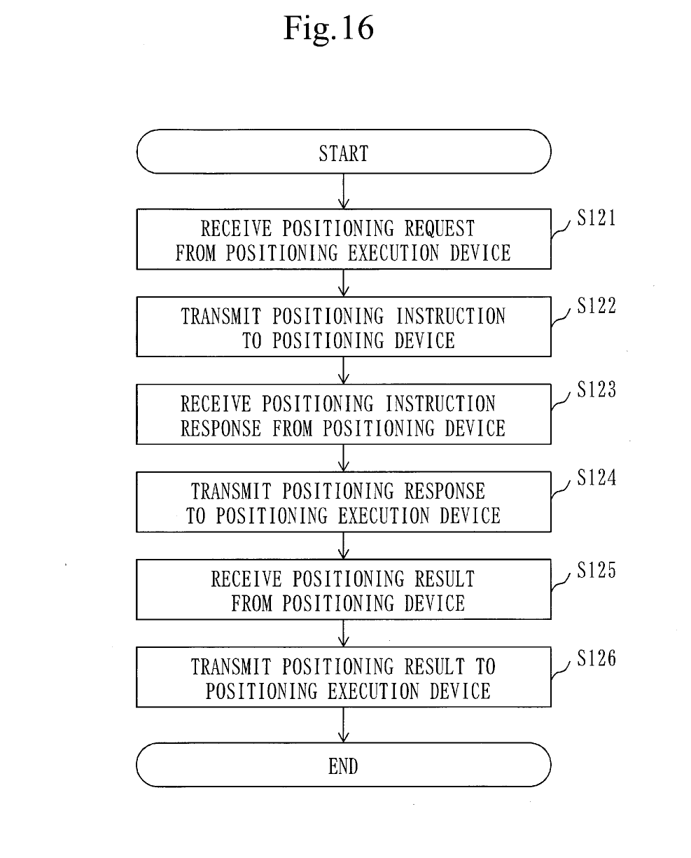

A positioning instruction process S200 of the positioning instruction device 200 according to the present embodiment will be described with reference to FIG. 16. The positioning instruction process S200 is executed by the positioning instruction part 230 and the communication part 220 of the positioning instruction device 200. The positioning instruction part 230 executes transmission and reception via the communication part 220.

In step S121, the positioning instruction part 230 of the positioning instruction device 200 receives the positioning request 31 from the positioning execution device 300.

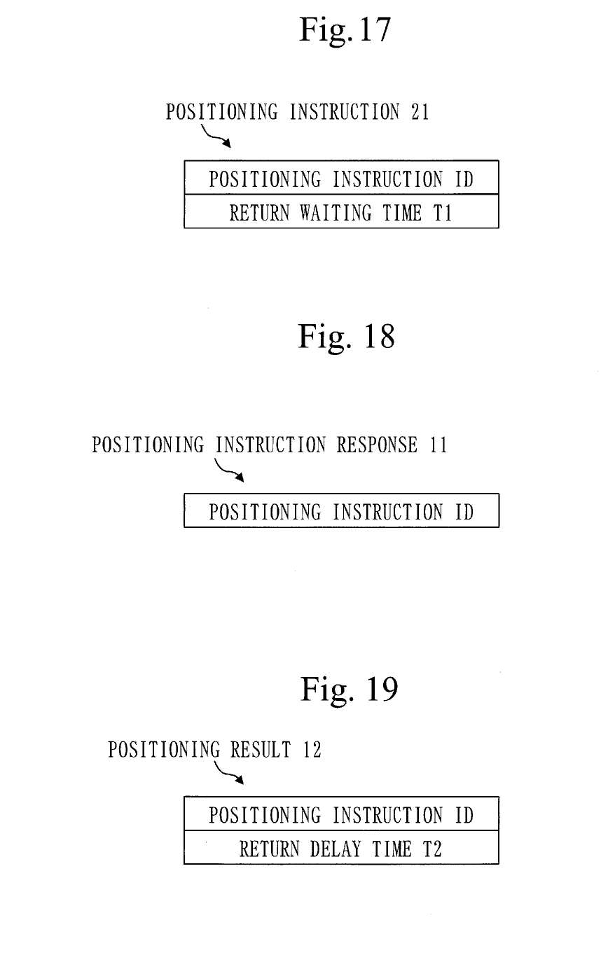

In step S122, the positioning instruction part 230 of the positioning instruction device 200 transmits the positioning instruction 21 to one or more of the positioning devices 100. FIG. 17 illustrates an example of the configuration of the positioning instruction 21. The positioning instruction 21 includes a positioning request ID and the return waiting time T1. The positioning instruction device 200 holds in advance a list of the positioning devices 100 to which the positioning instruction 21 is to be transmitted. Alternatively, the positioning instruction part 230 of the positioning instruction device 200 may acquire a list of the positioning devices 100 to which the positioning instruction 21 is to be transmitted from a database in the positioning instruction device 200 or outside the positioning instruction device 200. Moreover, the positioning instruction part 230 of the positioning instruction device 200 may transmit the positioning instruction 21 to all the positioning devices 100 or only some of the positioning devices 100 on the list of the positioning devices 100 acquired, the some of the positioning devices being extracted at random or by a predetermined method.

In step S123, the positioning instruction part 230 of the positioning instruction device 200 receives the positioning instruction response 11 from one or more of the positioning devices 100. FIG. 18 illustrates an example of the configuration of the positioning instruction response 11. The positioning instruction response 11 includes a positioning instruction ID. After the lapse of a predetermined time, the positioning instruction part 230 of the positioning instruction device 200 continues the process even when the positioning instruction response 11 is not received from all the positioning devices 100 to which the positioning instruction 21 is transmitted. The positioning instruction response 11 from the positioning device 100 may be received in any order.

In step S124, the positioning instruction part 230 of the positioning instruction device 200 transmits the positioning response 22 to the positioning execution device 300.

In step S125, the positioning instruction part 230 of the positioning instruction device 200 receives the positioning result 12 from one or more of the positioning devices 100. FIG. 19 illustrates an example of the configuration of the positioning result 12. The positioning result 12 includes the positioning instruction ID and the return delay time T2 at the positioning device 100 transmitting the positioning result 12. After the lapse of a predetermined time, the positioning instruction part 230 of the positioning instruction device 200 continues the process even when the positioning result 12 is not received from all the positioning devices 100 to which the positioning instruction 21 is transmitted. The positioning result 12 from the positioning device 100 may be received in any order.

In step S126, the positioning instruction part 230 of the positioning instruction device 200 transmits the positioning result 23 to the positioning execution device 300.

<Positioning Device Process S100 of Positioning Device 100>

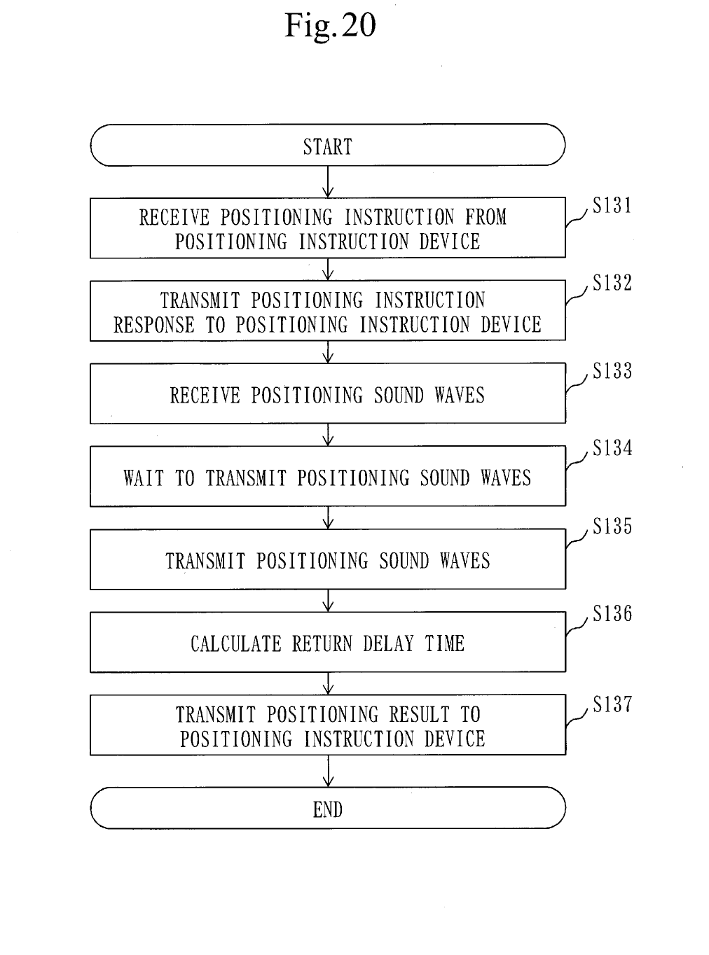

A positioning device process S 100 of the positioning device 100 according to the present embodiment will be described with reference to FIG. 20. The positioning device process S100 is executed by the positioning operation part 130, the communication part 120, the sound wave outputting part 131, and the sound wave inputting part 132 of the positioning device 100. The positioning operation part 130 executes transmission and reception via the communication part 120. The positioning operation part 130 also executes transmission and reception (input and output) of sound waves by using the sound wave outputting part 131 and the sound wave inputting part 132.

In step S131, the positioning operation part 130 of the positioning device 100 receives the positioning instruction 21 from the positioning instruction device 200.

In step S132, the positioning operation part 130 of the positioning device 100 transmits the positioning instruction response 11 to the positioning instruction device 200.

In step S133, the positioning operation part 130 of the positioning device 100 receives positioning sound waves. Although not illustrated, the positioning device 100 waits to receive the positioning sound waves until a predetermined time elapses, and continues the process when successfully receiving the sound waves. The device ends the process when failing to receive the sound waves.

In step S134, the positioning operation part 130 of the positioning device 100 waits for the return waiting time T1 included in the positioning instruction 21 before transmitting positioning sound waves.

In step S135, the positioning operation part 130 of the positioning device 100 transmits the positioning sound waves.

In step S136, the positioning operation part 130 of the positioning device 100 calculates the return delay time T2 before transmitting the positioning sound waves after receiving the positioning sound waves.

In step S137, the positioning operation part 130 of the positioning device 100 transmits the positioning result 12 to the positioning instruction device 200.

<Located Process 5500 of Device to be Located 500>

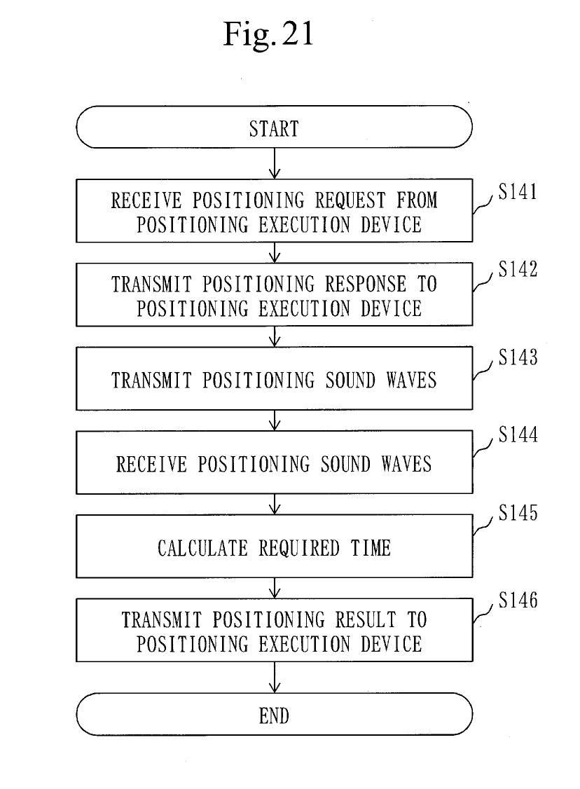

A located process S500 of the device to be located 500 according to the present embodiment will be described with reference to FIG. 21. The located process S500 is executed by the located operation part 530, the communication part 520, the sound wave outputting part 531, and the sound wave inputting part 532 of the device to be located 500. The located operation part 530 executes transmission and reception via the communication part 520. The located operation part 530 also executes transmission and reception (input and output) of sound waves by using the sound wave outputting part 531 and the sound wave inputting part 532.

In step S141, the located operation part 530 of the device to be located 500 receives the positioning request 32 from the positioning execution device 300.

In step S142, the located operation part 530 of the device to be located 500 transmits the positioning response 51 to the positioning execution device 300.

In step S143, the located operation part 530 of the device to be located 500 transmits positioning sound waves.

In step S144, the located operation part 530 of the device to be located 500 receives one or more positioning sound waves. After the lapse of a predetermined time, the located operation part 530 of the device to be located 500 continues the process even when the positioning sound waves corresponding to the number of positioning devices included in the positioning request 32 are not received.

In step S145, the located operation part 530 of the device to be located 500 measures the required time T3 for receiving the sound waves transmitted from the positioning device 100 after transmitting the sound waves. Specifically, the located operation part 530 of the device to be located 500 calculates the required time T3 for receiving each of the one or more positioning sound waves after transmitting the positioning sound waves.

In step S146, the located operation part 530 of the device to be located 500 transmits the positioning result 52 to the positioning execution device 300.

As described above, the positioning system 800 according to the present embodiment is brought into operation to enable the positioning execution device 300 to detect the location of the device to be located 500.

Another Configuration

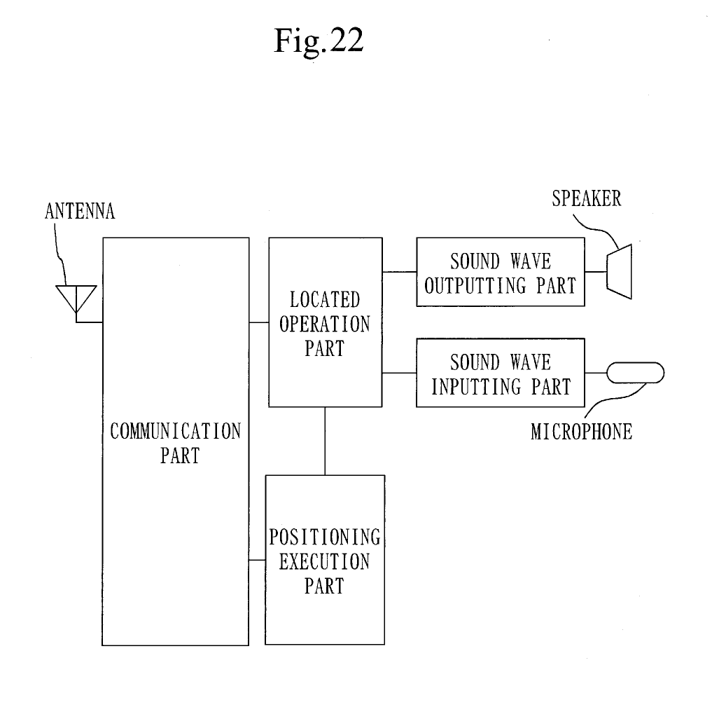

In the present embodiment, the positioning execution device 300, the positioning instruction device 200, the positioning device 100, and the device to be located 500 are described as mutually independent devices. However, as illustrated in FIGS. 22 to 24, the positioning execution device 300, the positioning instruction device 200, the positioning device 100, and the device to be located 500 can also be implemented in combination with one another.

FIG. 22 is an example in which the device to be located and the positioning execution device are implemented in the same apparatus. This apparatus includes a positioning execution part and a located operation part which are connected to each other. Among the communication performed between the positioning execution device and the device to be located as separate devices, the communication to be established with the device to be located included in this apparatus is exchanged between the positioning execution part and the located operation part in this apparatus.

The apparatus is configured as illustrated in FIG. 22 to allow the device to be located to instruct the execution of locating.

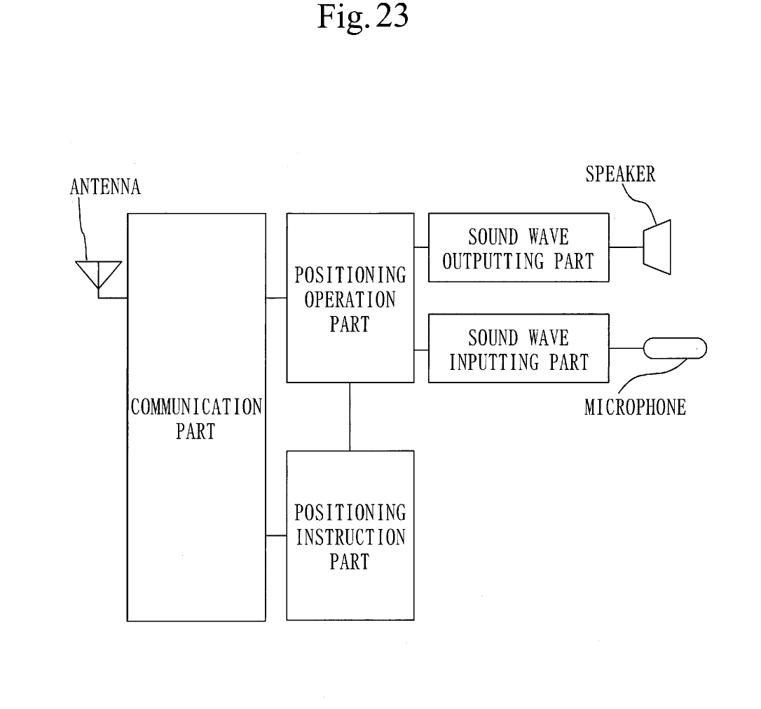

FIG. 23 is an example in which the positioning device and the positioning instruction device are implemented in the same apparatus. This apparatus includes a positioning instruction part and a positioning operation part which are connected to each other. Among the communication performed between the positioning instruction device and the positioning device as separate devices, the communication to be established with the positioning device included in this apparatus is exchanged between the positioning instruction part and the positioning operation part in this apparatus.

The apparatus is configured in this manner to be able to execute locating without provision of a device dedicated to positioning instructions.

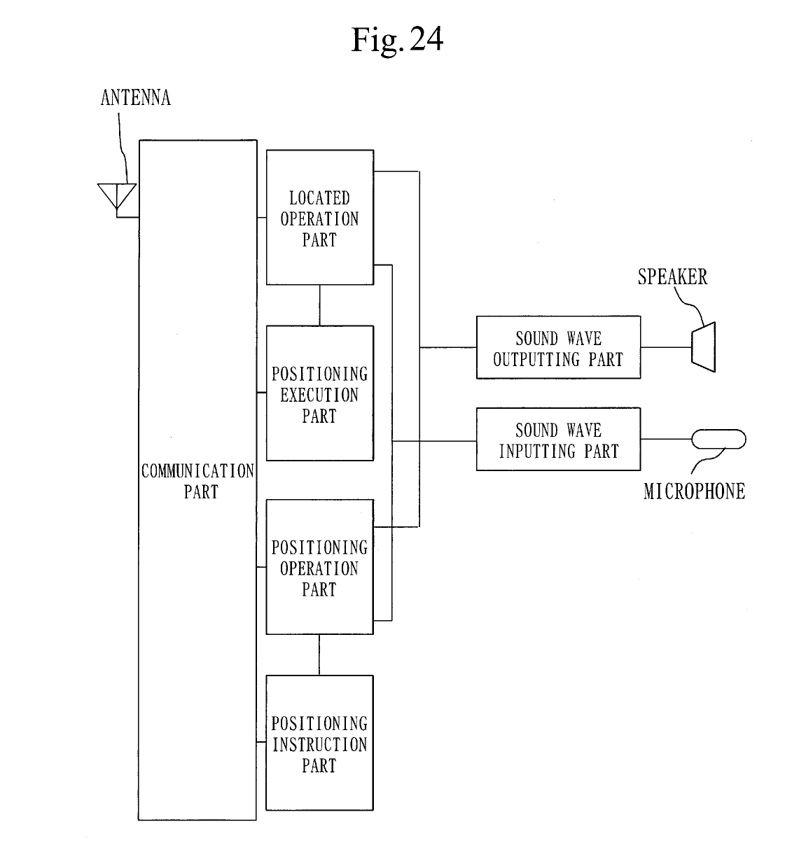

FIG. 24 is an example of an apparatus including all of the positioning execution device, the positioning instruction device, the positioning device, and the device to be located. The apparatus includes all of the positioning execution part, the positioning instruction part, the positioning operation part, and the located operation part, where the positioning execution part and the located operation part are connected to each other while the positioning instruction part and the positioning operation part are connected to each other. Among the communication performed between the positioning execution device and the device to be located as separate devices, the communication to be established with the device to be located included in this apparatus is exchanged between the positioning execution part and the located operation part in this apparatus. Moreover, among the communication performed between the positioning instruction device and the positioning device as separate devices, the communication to be established with the positioning device included in this apparatus is exchanged between the positioning instruction part and the positioning operation part in this apparatus.

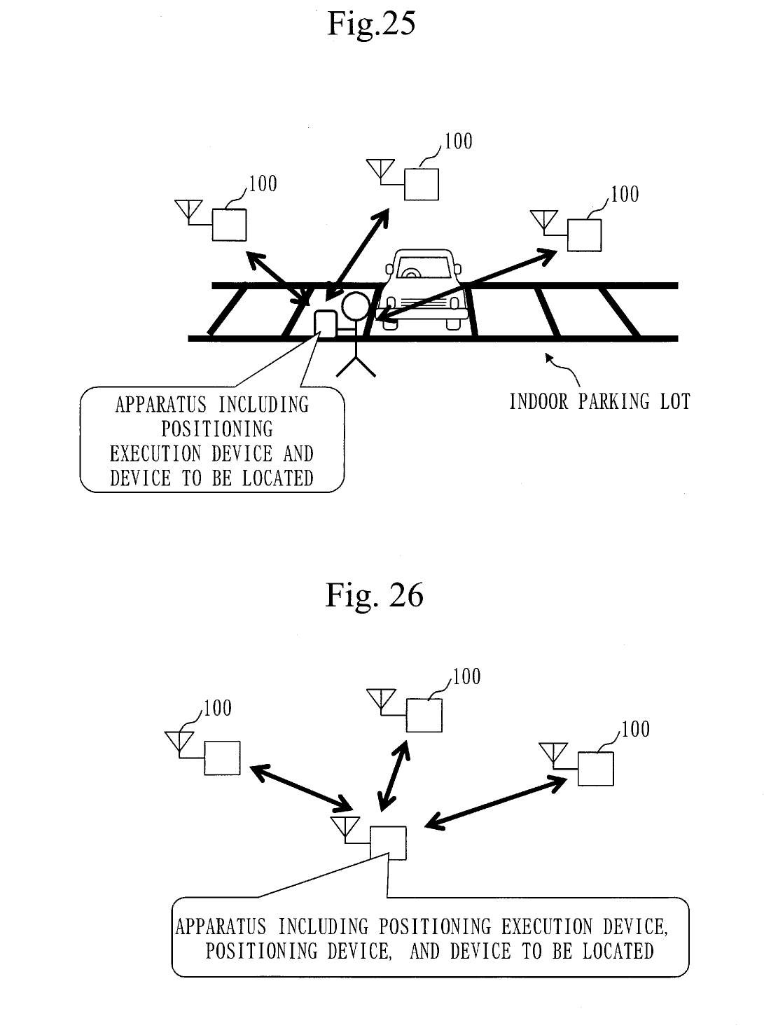

Next, an example of the use of the positioning system 800 according to the present embodiment will be described with reference to FIGS. 25 and 26.

The example described here uses the apparatus in which the positioning execution device 300, the positioning instruction device 200, the positioning device 100, and the device to be located 500 are implemented in combination with one another as illustrated in FIGS. 22 to 24.

FIG. 25 illustrates an example of the positioning system 800 used for location detection in an indoor parking lot. The positioning device 100 is placed on the wall or the like in the indoor parking lot. A user holds a device including both the positioning execution device 300 and the device to be located 500, specifically a smart phone on which an application implementing the positioning execution part and the located operation part is running. When the user runs the positioning execution part near a parked vehicle, the positioning system 800 operates to identify the location of the device possessed by the user, that is, the location of the user's vehicle. The location identified in this way can be used for navigation when the user returns to the location of his vehicle from outside the parking lot, for example.

FIG. 26 illustrates an example of automatically detecting the location of the positioning device. The positioning device is further equipped with the positioning execution device and the device to be located. When being newly installed, the positioning device serves as the positioning execution device to activate the positioning system, thereby detecting the location of its own positioning device which is also the device to be located. As a result, the location of the positioning device being installed is automatically detected.

Moreover, although the functions of the “parts” of each of the positioning execution device 300, the positioning instruction device 200, the positioning device 100, and the device to be located 500 are implemented in software in the present embodiment, the functions of the “parts” of each device may be implemented in hardware as a variation.

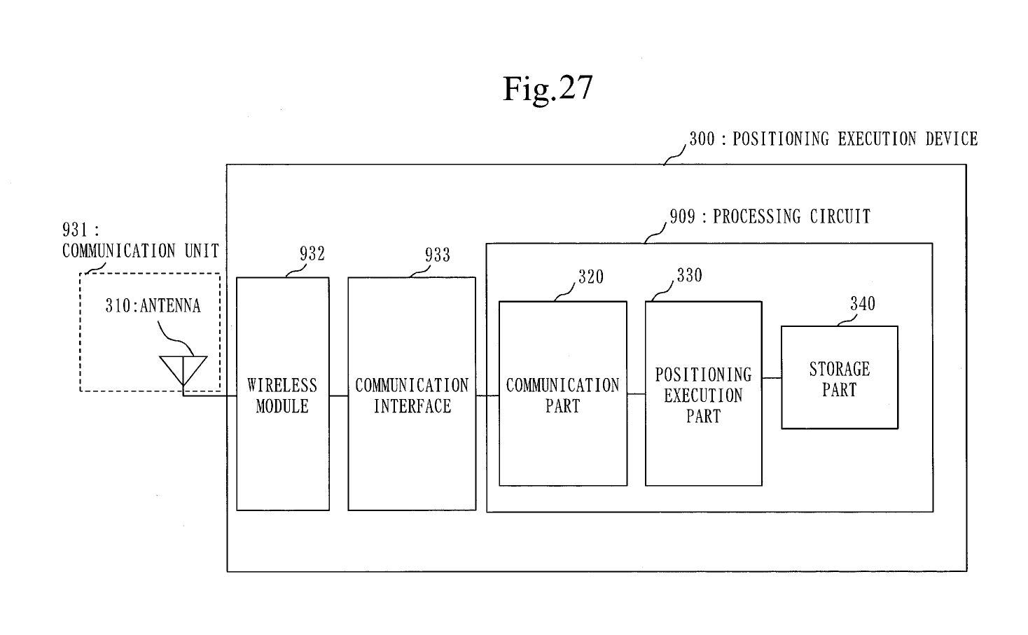

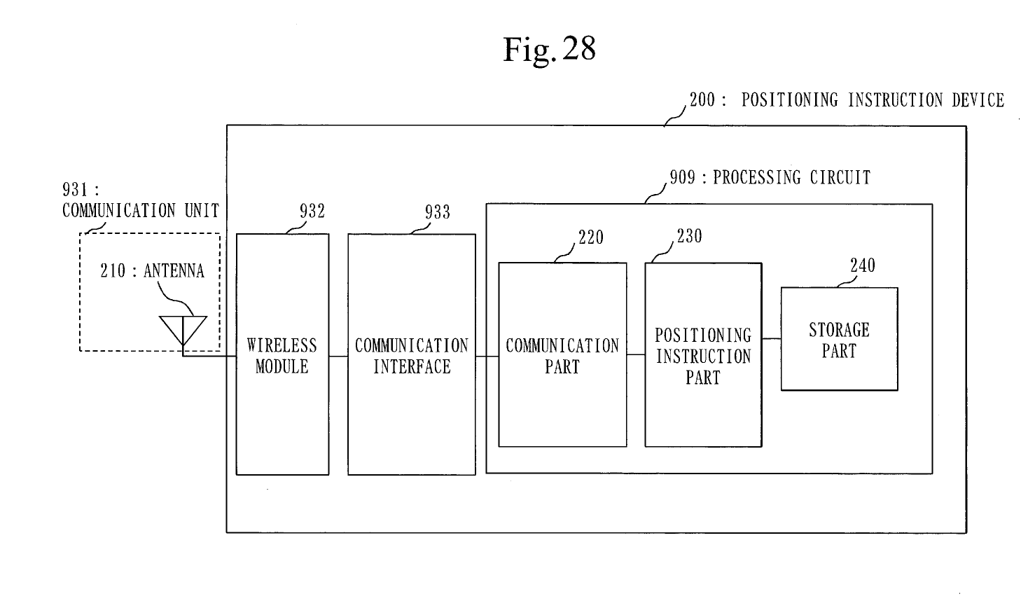

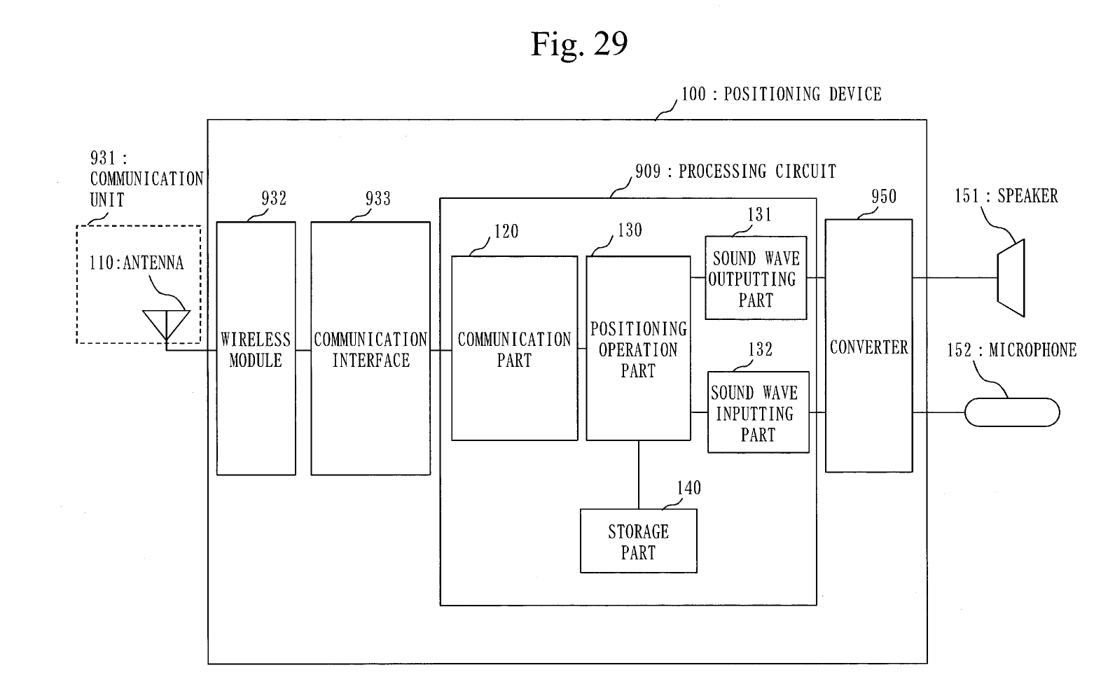

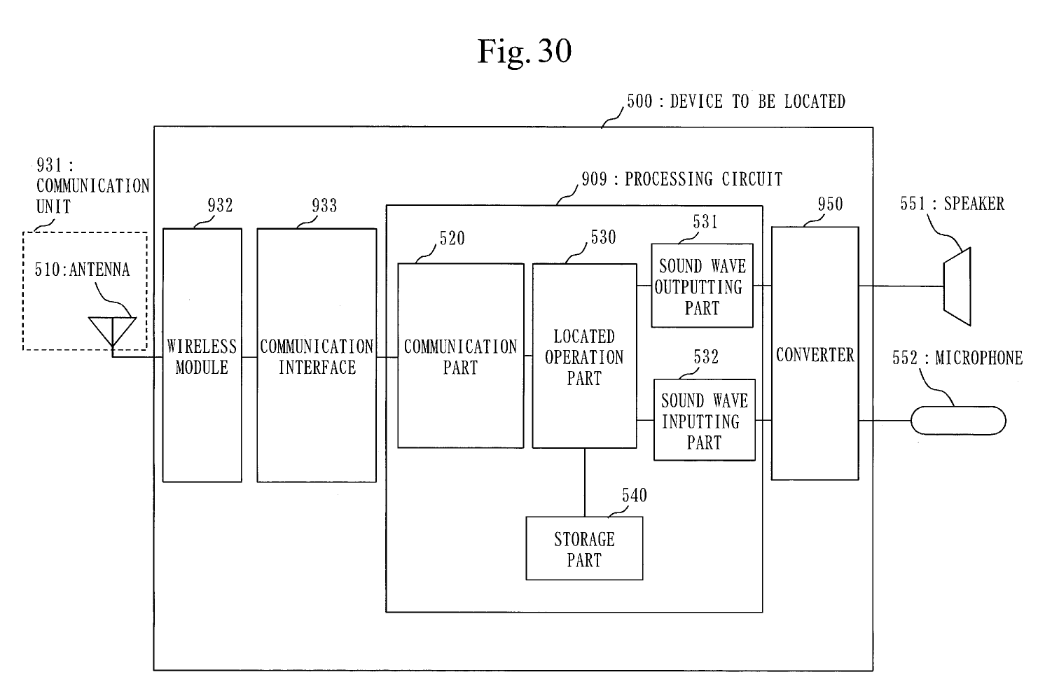

A variation of the configuration of each of the positioning execution device 300, the positioning instruction device 200, the positioning device 100, and the device to be located 500 will be described with reference to FIGS. 27 to 30. In the following description, each of the positioning execution device 300, the positioning instruction device 200, the positioning device 100, and the device to be located 500 will be referred to as each device.

As illustrated in FIGS. 27 to 30, each device includes a processing circuit 909 in place of the CPU 910 and the storage 920.

The processing circuit 909 is a dedicated electronic circuit implementing the functions of the “parts” of each device described above and the storage part of each device. Specifically, the processing circuit 909 can be a single circuit, a composite circuit, a programmed processor, a parallel-programmed processor, a logic IC, a gate array (GA), an application specific integrated circuit (ASIC), or a field-programmable gate array (FPGA).

The functions of the “parts” of each device may be implemented by one processing circuit 909 or may be distributed into a plurality of the processing circuits 909 to be implemented.

As another variation, the functions of the “parts” of each device and the storage part of each device may be implemented by a combination of software and hardware. That is, some of the functions of each device may be implemented in dedicated hardware, and the rest of the functions may be implemented in software.

The CPU 910, the storage 920, and the processing circuit 909 are collectively referred to as “processing circuitry”. That is, the functions of the “parts” are implemented by the processing circuitry regardless of the configuration of each device illustrated in any of FIGS. 2 to 5 and FIGS. 27 to 30.

The “part” may be interpreted as a “step”, a “procedure”, or “processing”.

The functions of the “parts” may also be implemented in firmware.

Description of Effect of Present Embodiment

As described above, the positioning system according to the present embodiment can calculate the location information of the device to be located with high accuracy with the simple configuration without using special equipment.

### Second Embodiment

The present embodiment mainly describes points that are different from the first embodiment.

The positioning system 800 of the first embodiment is configured to output the positioning sound waves from the device to be located 500 to the positioning device 100. The present embodiment describes a positioning system 800x that outputs positioning sound waves from the positioning device 100 to the device to be located 500.

Note that in the present embodiment, a configuration similar to that described in the first embodiment will be denoted by the same reference numeral as that assigned to such configuration in the first embodiment, and the description of such configuration may be omitted in some cases.

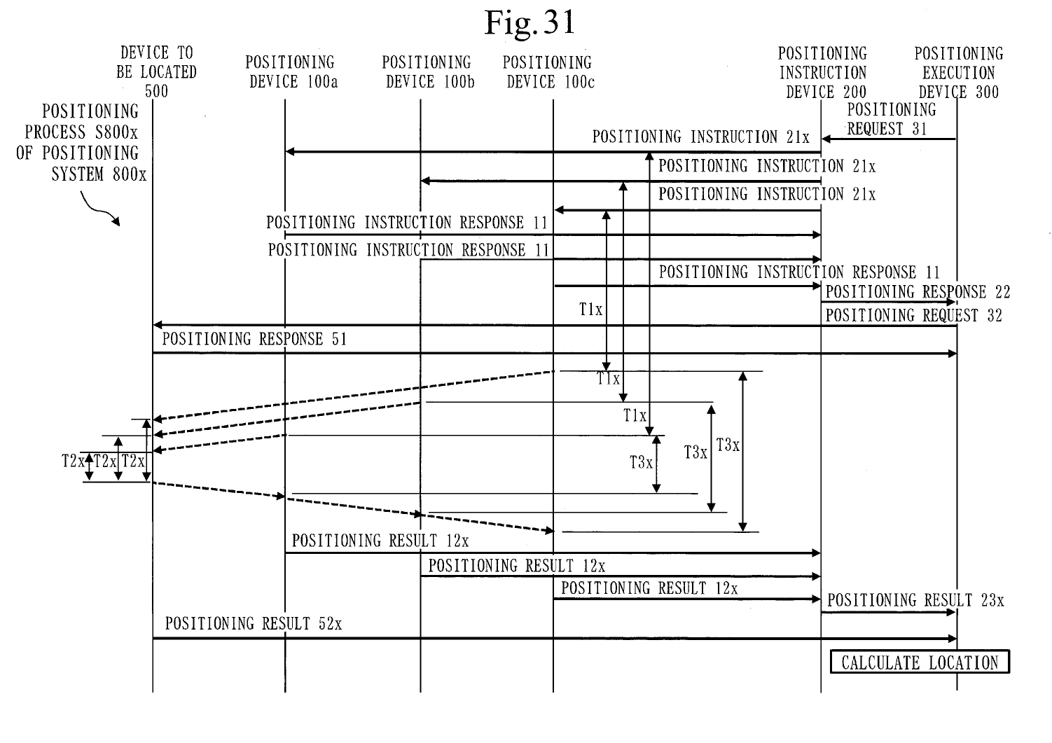

The operation sequence of a positioning process S800x of the positioning system 800x according to the present embodiment will be described with reference to FIG. 31.

The positioning execution device 300 transmits the positioning request 31 that requests locating of the device to be located 500.

Upon receiving the positioning request 31, the positioning instruction device 200 transmits, to the positioning device 100, a positioning instruction 21x that is a positioning instruction 21 instructing locating of the device to be located 500 and includes transmission waiting time T1x. Specifically, the positioning instruction device 200 receives the positioning request 31 and then transmits the positioning instruction 21x to each of the positioning devices 100a, 100b, and 100c.

Each of the positioning devices 100a, 100b, and 100c receives the positioning instruction 21x and then transmits the positioning instruction response 11 to the positioning instruction device 200. The positioning instruction device 200 receives the positioning instruction response 11 from each of the positioning devices 100a, 100b, and 100c, and then transmits the positioning response 22 to the positioning execution device 300.

The positioning execution device 300 transmits the positioning request 32 to the device to be located 500. The device to be located 500 receives the positioning request 32 and then transmits the positioning response 51 to the positioning execution device 300.

The positioning device 100 receives the positioning instruction 21x transmitted from the positioning instruction device 200, and then transmits sound waves to the device to be located 500 after the lapse of the transmission waiting time T1x included in the positioning instruction 21x. Specifically, each of the positioning devices 100a, 100b, and 100c transmits the sound waves after the lapse of the transmission waiting time T1x from the reception of the positioning instruction 21x.

The device to be located 500 receives the sound waves transmitted from each of the positioning devices 100a, 100b, and 100c, and then transmits sound waves. That is, the device to be located 500 receives the sound waves transmitted from the positioning device 100, and then transmits the sound waves to the positioning device 100.

The device to be located 500 measures return delay time T2x which is the time before transmitting the sound waves after receiving the sound waves transmitted from each of the positioning devices 100a, 100b, and 100c.

Each of the positioning devices 100a, 100b, and 100c receives the sound waves transmitted from the device to be located 500 and measures, as required time T3x, the time required for receiving the sound waves transmitted by the device to be located 500 after transmitting the sound waves.

After receiving the sound waves, each of the positioning devices 100a, 100b, and 100c transmits a positioning result 12x to the positioning instruction device 200. The positioning result 12x includes the required time T3x. That is, the positioning device 100 transmits the required time T3x to the positioning instruction device 200.

The positioning instruction device 200 receives the positioning result 12x from each of the positioning devices 100a, 100b, and 100c, and then transmits a positioning result 23x to the positioning execution device 300. The positioning result 23x includes a positioning device ID of each of the positioning devices 100a, 100b, and 100c in association with the required time T3x received from each of the positioning devices 100a, 100b, and 100c. That is, the positioning instruction device 200 transmits the required time T3x received from the positioning device 100 to the positioning execution device 300.

After outputting the sound waves to each of the positioning devices 100a, 100b, and 100c, the device to be located 500 transmits a positioning result 52x to the positioning execution device 300. The positioning result 52x includes the return delay time T2x in order such as in ascending order. That is, the device to be located 500 transmits the return delay time T2x to the positioning execution device 300.

The positioning execution device 300 receives the positioning results 23x and 52x from the positioning instruction device 200 and the device to be located 500, thereby calculating the location of the device to be located 500 from the return delay time T2x and the required time T3x included in the positioning results 23x and 52x. That is, the positioning execution device 300 calculates the distance between the positioning device 100 and the device to be located 500 by using the required time T3x for the positioning device 100 to receive the sound waves transmitted by the device to be located 500 after transmitting the sound waves, and the return delay time T2x before the device to be located 500 transmits the sound waves to the positioning device 100 after receiving the sound waves. The positioning execution device 300 then calculates the location of the device to be located 500 by using the distance between the positioning device 100 and the device to be located 500.

The operation flow of the positioning execution device 300 according to the present embodiment is identical to the positioning execution process 5300 of the positioning execution device 300 described with reference to FIG. 9.

Moreover, the operation flow of the positioning instruction device 200 according to the present embodiment is identical to the positioning instruction process 5200 of the positioning instruction device 200 described with reference to FIG. 16.

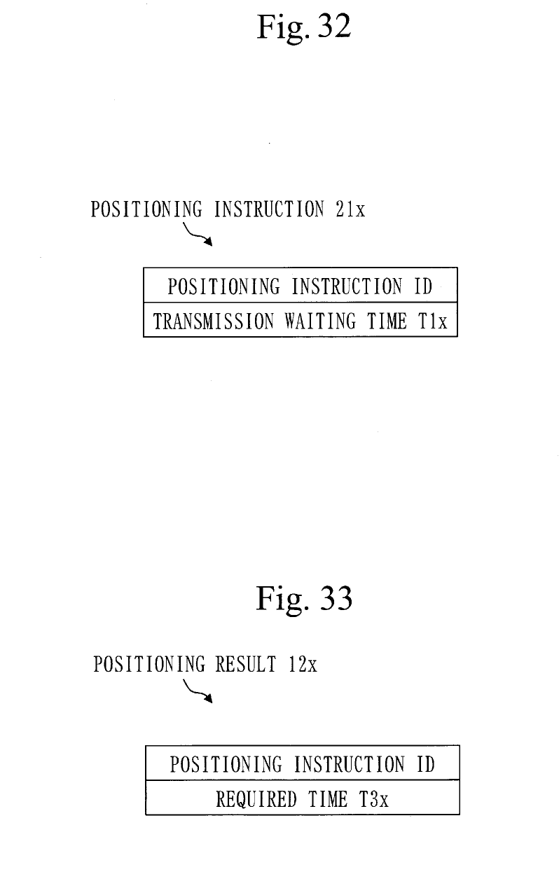

Note, however, that the positioning instruction 21x transmitted from the positioning instruction device 200 to the positioning device 100 includes the transmission waiting time T1x instead of the return waiting time T1 described in the description of the positioning instruction 21 according to the first embodiment. FIG. 32 illustrates an example of the configuration of the positioning instruction 21x according to the present embodiment.

Moreover, the positioning result 12x transmitted from the positioning device 100 to the positioning instruction device 200 includes the required time T3x instead of the return delay time T2 described in the description of the positioning result 12 according to the first embodiment. FIG. 33 illustrates an example of the configuration of the positioning result 12x according to the present embodiment.

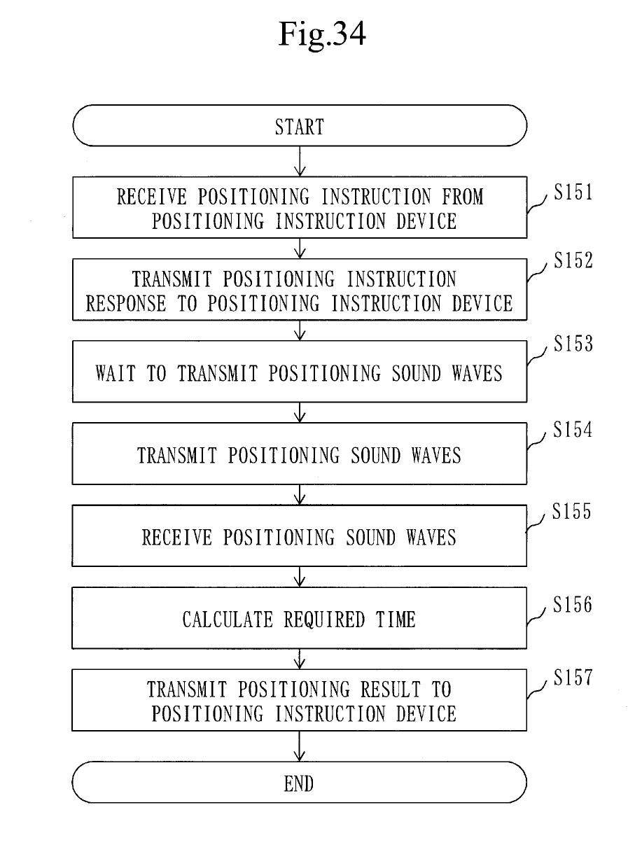

A positioning device process S100x of the positioning device 100 according to the present embodiment will be described with reference to FIG. 34.

In step S151, the positioning device 100 receives the positioning instruction 21x from the positioning instruction device 200.

In step S152, the positioning device 100 transmits the positioning instruction response 11 to the positioning instruction device 200.

In step S153, the positioning device 100 waits for the transmission waiting time T1x included in the positioning instruction 21x before transmitting the positioning sound waves.

In step S154, the positioning device 100 transmits the positioning sound waves.

In step S155, the positioning device 100 receives positioning sound waves. Although not illustrated, the positioning device 100 waits to receive the positioning sound waves until a predetermined time elapses, and continues the process when successfully receiving the sound waves. The device ends the process when failing to receive the sound waves.

In step S156, the positioning device 100 calculates the required time T3x for receiving the positioning sound waves after transmitting the positioning sound waves.

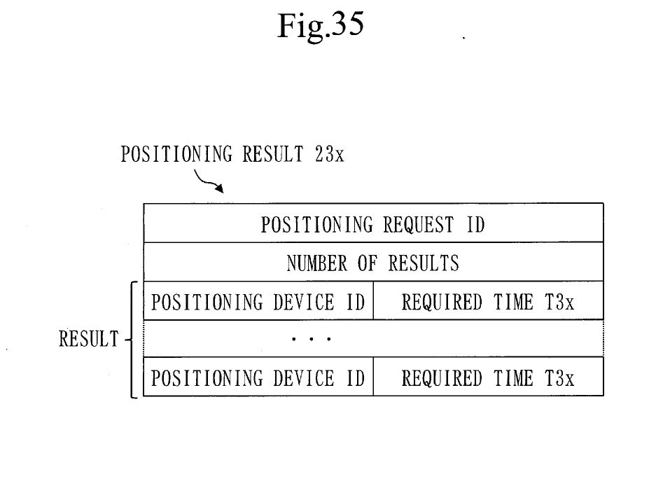

In step S157, the positioning device 100 transmits the positioning result 23x to the positioning instruction device 200. FIG. 35 illustrates an example of the configuration of the positioning result 23x. The positioning result 23x includes a positioning request ID, the number of results, and the required time T3x in the positioning device 100 identified by the positioning device ID.

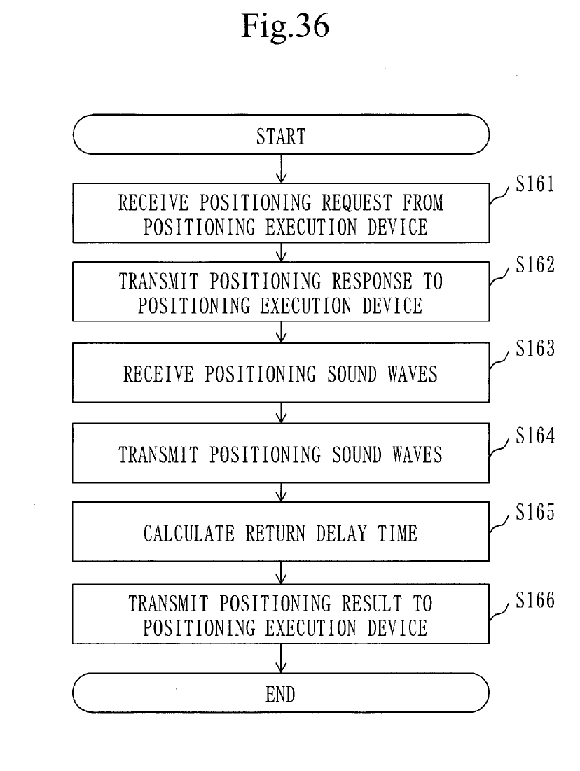

A located process S500x of the device to be located 500 according to the present embodiment will be described with reference to FIG. 36.

In step S161, the device to be located 500 receives the positioning request 32 from the positioning execution device 300.

In step S162, the device to be located 500 transmits the positioning response 51 to the positioning execution device 300.

In step S163, the device to be located 500 receives positioning sound waves. After the lapse of a predetermined time, the device to be located 500 continues the process even when the sound waves corresponding to the number of positioning devices included in the positioning request 32 are not received.

In step S164, the device to be located 500 transmits positioning sound waves.

In step S165, the device to be located 500 measures the return delay time T2x before transmitting the sound waves after receiving the sound waves transmitted by the positioning device 100. Specifically, the device to be located 500 calculates the return delay time T2x before transmitting the sound waves after receiving the sound waves for one or more of the sound waves being received.

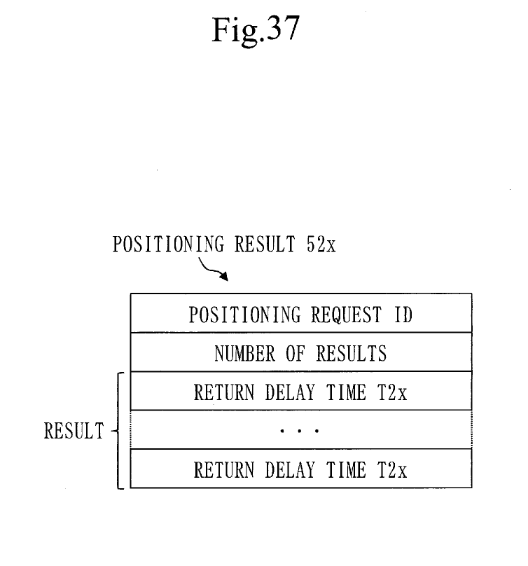

In step S166, the device to be located 500 transmits the positioning result 52x to the positioning execution device 300. FIG. 37 illustrates an example of the configuration of the positioning result 52x. The positioning result 52x includes a positioning request ID, the number of results, and one or more of the return delay times T2x. The return delay time T2x is included in order, such as in ascending order, of the return delay time T2x.

As described above, the positioning system 800x according to the present embodiment is brought into operation to enable the positioning execution device 300 to detect the location of the device to be located 500.

As described above, the positioning system 800x according to the present embodiment can calculate the location information of the device to be located with high accuracy without using special equipment.

The first and second embodiments of the present invention have been described above, where only one or some arbitrary combinations of the “parts” described in these embodiments may be employed. That is, the functional blocks of each of the positioning execution device 300, the positioning instruction device 200, the positioning device 100, and the device to be located 500 are set at will as long as the functions described in the above embodiments can be implemented. These functional blocks may be in any combination or any block configuration to configure each device. Moreover, each device may be a system made up of a plurality of devices instead of a single device.

Furthermore, although the first and second embodiments have been described, a plurality of these two embodiments may be partially combined and implemented. Alternatively, one of the two embodiments may be partially implemented. Yet alternatively, the two embodiments may be implemented wholly or partially in any combination.

Note that the above embodiments are preferred examples in nature and are not intended to limit the scope of the present invention, its application or uses but can be modified in various ways as appropriate.

### REFERENCE SIGNS LIST

11: positioning instruction response, 21, 21x: positioning instruction, 22, 51: positioning response, 12, 12x, 23, 23x, 52, 52x: positioning result, 31, 32: positioning request, 100, 100a, 100b, 100c: positioning device, 110: antenna, 120: communication part, 130: positioning operation part, 131: sound wave outputting part, 132: sound wave inputting part, 140, 240, 340, 540: storage part, 151: speaker, 152: microphone, 200: positioning instruction device, 210: antenna, 220: communication part, 230: positioning instruction part, 300: positioning execution device, 310: antenna, 320: communication part, 330: positioning execution part, 500: device to be located, 510: antenna, 520: communication part, 530: located operation part, 531: sound wave outputting part, 532: sound wave inputting part, 551: speaker, 552: microphone, 610: positioning method, 620: positioning program, 800, 800x: positioning system, 909: processing circuit, 910: CPU, 920: storage, 921: memory, 922: auxiliary storage, 931: communication unit, 932: wireless module, 933: communication interface, 950: converter, T1: return waiting time, T2, T2x: return delay time, T3, T3x: required time, T1x: transmission waiting time, S100, S100x: positioning device process, S800, S800x: positioning process.

1-18. (canceled)

19. A positioning system comprising:
a device to be located;
a plurality of positioning devices;
a positioning execution device to transmit a positioning request that requests locating of the device to be located; and
a positioning instruction device to transmit, upon receiving the positioning request, to each of the plurality of positioning devices a positioning instruction that instructs locating of the device to be located and includes return waiting time corresponding to each of the plurality of positioning devices, wherein
the device to be located transmits sound waves upon receiving the positioning request,
each of the plurality of positioning devices receives the sound waves transmitted from the device to be located and then transmits sound waves to the device to be located after a lapse of the return waiting time included in the positioning instruction, and
the positioning execution device calculates a distance between each of the plurality of positioning devices and the device to be located by using required time for the device to be located to receive the sound waves transmitted by each of the plurality of positioning devices after transmitting the sound waves and return delay time before each of the plurality of positioning devices transmits the sound waves to the device to be located after receiving the sound waves, and calculates a location of the device to be located by using the distance between each of the plurality of positioning devices and the device to be located.

20. The positioning system according to claim 19, wherein
each of the plurality of positioning devices transmits the return delay time to the positioning instruction device,
the positioning instruction device transmits the return delay time received from each of the plurality of positioning devices to the positioning execution device, and
the device to be located transmits the required time to the positioning execution device.

21. The positioning system according to claim 19, wherein
each of the plurality of positioning devices measures the return delay time before transmitting the sound waves after receiving the sound waves transmitted from the device to be located.

22. The positioning system according to claim 19, wherein
the device to be located measures the required time for receiving the sound waves transmitted from each of the plurality of positioning devices after transmitting the sound waves.

23. The positioning system according to claim 19, wherein
the positioning instruction device and the positioning execution device perform wireless communication.

24. The positioning system according to claim 19, wherein
each of the plurality of positioning devices and the positioning instruction device are implemented on the same apparatus.

25. The positioning system according to of claim 19, wherein
the device to be located and the positioning execution device are implemented on the same apparatus.

26. A positioning method comprising:
by a positioning execution device, transmitting a positioning request that requests locating of a device to be located;
by a positioning instruction device, transmitting, upon receiving the positioning request, to each of a plurality of positioning devices a positioning instruction that instructs locating of the device to be located and includes return waiting time corresponding to each of the plurality of positioning devices;
by the device to be located, transmitting sound waves upon receiving the positioning request;
by each of the plurality of positioning devices, receiving the sound waves transmitted from the device to be located and then transmitting sound waves to the device to be located after a lapse of the return waiting time included in the positioning instruction; and
by the positioning execution device, calculating a distance between each of the plurality of positioning devices and the device to be located by using required time for the device to be located to receive the sound waves transmitted by each of the plurality of positioning devices after transmitting the sound waves and return delay time before each of the plurality of positioning devices transmits the sound waves to the device to be located after receiving the sound waves, and calculating a location of the device to be located by using the distance between each of the plurality of positioning devices and the device to be located.
